(19) United States
(12) Patent Application Publication
(10) Pub. No.: US 2006/0080669 A1
(43) Pub. Date: Apr. 13, 2006

(54) Method for saving the same sequence of messages in several data sinks

(75) Inventors: Jorg Deister, Peine (DE); Ingo Kunz, Braunschweig (DE); Rainer Korner, Liebenburg (DE); Bernd Prade, Baddeckenstedt (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/533,313

(22) PCT Filed: Oct. 21, 2003
(86) PCT No.: PCT/DE03/03543

§ 371 Date: Apr. 29, 2005

(30) Foreign Application Priority Data
Oct. 31, 2002 (DE) 102 51 654.5

(51) Int. Cl. G06F 9/44

(52) U.S. Cl. 719/313

(57) ABSTRACT

The invention relates to a method for saving the same sequence of messages in several data sinks (DS), several data sources (DQ) independently sending data messages comprising identical message contents to said data sinks (DS) in a parallel manner. In order for the same sequence of messages to be saved, the data sinks (DS) predefine a time slot for the data sources (DQ) to collect the data messages, and the data messages are sent when said time slot is closed.

The invention relates to a method for ensuring the same order of messages in a plurality of data sinks in accordance with the preamble of claim 1. In the case of multicomputer systems, in particular, it is necessary for the receivers, or data sinks, to receive the data messages originating from a plurality of transmitters, or data sources, in the same order. This requires a constrained synchronization of the data sinks.

The invention is based on the object of specifying a method of the generic type in which the data sinks are synchronized in such a way as to ensure the same message order of the data messages with identical message contents from different data sources.

The object is achieved according to the invention by means of the characterizing features of claim 1. What is achieved by means of the time window for collection of the data messages is that the data messages from all the data sources are processed in the same order in each data sink and thus lead to a synchronous operation of the data sinks. It is only when the time window is closed that the collected messages are forwarded to the data sinks for processing in a manner sorted according to sender.

In accordance with claim 2, the data sinks transmit an S_{ON} message to the data sources for the purpose of closing the time window, a reception window of the data sinks simultaneously being opened. In this way, the clapsing of the collection time for the data messages is immediately followed by the issuing of a transmit enable for sending the next data messages to the connected data sinks.

In accordance with claim 3, the length of the reception window is defined by means of an S_{OFF} telegram transmitted to the data sinks by the data sources. The temporal length of the reception window is delimited in such a way as to ensure a uniform loading of the communication media. It is only when the S_{ON} messages from all the connected data sinks have been received that the reception window of the data sinks is closed. The cycle then begins anew. The new messages collected during the transmission time, i.e. within the reception window, are enabled for transmission to the data sinks by the sending of the next S_{ON} messages.

In order to unambiguously identify the cycle, in accordance with claim 4, a consecutive token number is transmitted to the data sources with the S_{ON} message from the data sinks, and is sent back to the data sinks with the S_{OFF} message from the data sources. What is achieved in this way is that double S_{OFF} message that may occur as a result of a data source newly connected in are sorted out, whereby the new data source can be synchronized into current operation. The token number of each cycle is matching for all the data sinks and is incremented by one for each new cycle, i.e. for each new S_{ON} message. For the case where a new data source is added, this data source transmits its first S_{OFF} data message with the token number 0 and is updated with regard to the token number by means of the following S_{ON} message.

The invention is explained in more detail below on the basis of figurative illustrations, in which:

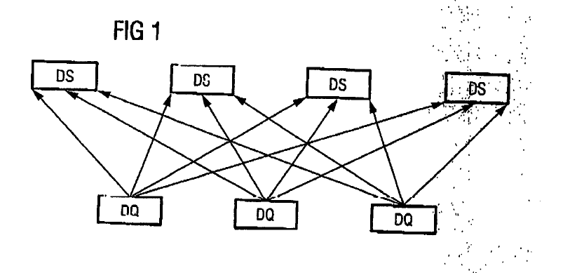

FIG. 1 shows a schematic illustration of a communication structure, and

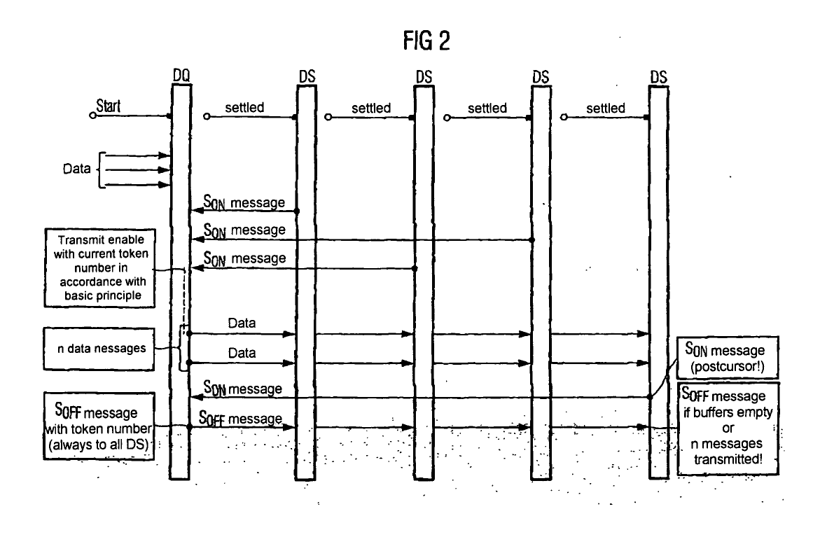

FIG. 2 shows a diagrammatic method sequence for ensuring the same order of messages in the case of a communication structure in accordance with FIG. 1.

FIG. 1 shows three data sources DQ that transmit identical message contents to four data sinks DS in parallel, but independently of one another.

In order to ensure that the data messages arrive at the data sinks DS in the same order as they are generated by the data sources DQ, a cyclic transmission method is provided, which is illustrated in FIG. 2. After the start of the communication, firstly data are collected in the data sources DQ, the transmit enable of said data being effected by means of S_{ON} messages from the data sinks DS. The first cycle thus begins. It is evident that firstly only three of the four data sinks DS are connected to the data sources DQ. After the transmit enable, the data messages are transmitted from the data sources DQ to the individual data sinks DS. If the data source buffers in which the message contents of the data messages were stored are empty or a specific maximum number of messages have been transmitted, the data sources DQ report this state to all the data sinks DS by means of an S_{OFF} message. The reception window is thus closed. The first cycle is ended. Afterward, or in a manner temporally superposed with respect to the first cycle, the second cycle begins with the collection, i.e. the storage of the next data messages in the data sources DQ. Each cycle is identified by a consecutive token number. This token number is generated by the data sinks DS and appended to the S_{ON} message. In order that the cycles proceed synchronously with one another in the data sinks DS, the respective token number is transmitted back to all the data sinks DS by the S_{OFF} messages from the data sources DQ. It is evident in FIG. 2 that the fourth data sink DS is linked into the communication process as it were as a postcursor during the operating sequence. This new data sink DS registers itself at all the data sources DQ by means of an S_{ON} message and the token number 0. In the next cycle, this data sink DS is integrated into the method sequence with the current token number. This data sink DS has thus also been synchronized. The data messages received by the data sinks DS thus arrive in the same order as they are collected and sent by the data sources DQ.

The invention is not restricted to the exemplary embodiment mentioned above. Moreover, a number of variants are conceivable which make use of the features of the invention even with an embodiment of a fundamentally different configuration.

1. A method for ensuring the same order of messages in a plurality of data sinks (DS), a plurality of data sources (DQ) transmitting data messages with identical message contents to the data sinks (DS′) in parallel and independently of one another,
characterized
in that the data sinks (DS) predefine for the data sources (DQ) a time window for the collection of the data messages, the data messages being sent when the time window is closed.

2. The method as claimed in claim 1,
characterized
in that the time window is closed by means of an S_{ON} message transmitted to the data sources (DQ) by the data sinks (DS), the S_{ON} message simultaneously opening a reception window above the data sinks (DS).

3. The method as claimed in claim 2,
characterized
in that the reception window is closed by means of an S_{OFF} message transmitted to the data sinks (DS) by the data sources (DQ).

4. The method as claimed in claim 3,
characterized
in that a consecutive token number is transmitted to the data source (DQ) with the S_{ON} message from the data sinks (DS), and is sent back to the data sinks (DS) with the S_{OFF} messages from the data sources (DQ).
